(19) United States
(12) Patent Application Publication
(10) Pub. No.: US 2011/0080570 A1
(43) Pub. Date: Apr. 7, 2011

(54) EXPOSURE APPARATUS AND EXPOSURE METHOD

(76) Inventor: Hideaki Sunohara, Osaka (JP)

(21) Appl. No.: 12/996,955

(22) PCT Filed: Apr. 22, 2009
(86) PCT No.: PCT/JP2009/057953

§ 371 Date: Dec. 8, 2010

(30) Foreign Application Priority Data
Jun. 9, 2008 (JP) 2008-150279

(51) Int. Cl. G03B 27/42

(52) U.S. Cl. 355/53

(57) ABSTRACT

An exposure apparatus and an exposure method by which alignment of regions of a substrate that are to be exposed by optical systems can be performed with accuracy even if the substrate is deformed nonuniformly within a plane. A step-and-scan exposure apparatus (1) for performing exposure on a substrate (5) that is a subject to be exposed includes a plurality of mark detection systems (20) capable of detecting alignment marks (52) provided on the substrate (5), and a plurality of projection optical systems (15) capable of illuminating corresponding projection regions (F₁ to F₇) set on the subject (5) with light energy, wherein the mark detection systems (20) are disposed between the adjacent projection optical systems (15) and on right and left sides of the endmost projection optical systems (15).

### TECHNICAL FIELD

The present invention relates to an exposure apparatus and an exposure method, and specifically relates to an exposure apparatus and an exposure method that are suitably used in the process of manufacturing a substrate for a liquid crystal display panel by photolithography.

### BACKGROUND ART

A general liquid crystal display panel includes a pair of substrates. The substrates are disposed opposed to each other leaving a given small gap therebetween, and liquid crystals are filled between the substrates. Given elements including pixel electrodes capable of applying a given voltage to the liquid crystals, switching elements (e.g., thin film transistors) that drive the pixel electrodes, and a variety of lines such as signal lines and scanning lines are laminated in given order on one of the substrates. Given elements including a black matrix, color layers of given colors, and a common electrode are laminated in given order on the other substrate.

Some of the elements including the thin film transistors, the variety of lines such as the signal lines and the scanning lines, the black matrix, and the color layers are formed by photolithography. Photolithography includes a process of illuminating a photo resist applied on a substrate with light energy (exposing light) through a photo mask that consists of a translucent portion having a given pattern, and a light shielding portion having a given pattern.

An exposure apparatus used in photolithography includes a mask stage on which the photo mask is to be placed, a substrate stage on which the substrate provided with the photo resist is to be placed, and a projection optical system including given lenses. The exposure apparatus is capable of projecting (transferring) the patterns from the photo mask onto the photo resist applied on the substrate via the projection optical system including the given lenses while moving the mask stage and the substrate stage.

Conventionally, for the exposure apparatus, there is known a scanning exposure apparatus that is capable of projecting (transferring) in succession the patterns from the photo mask onto the photo resist applied on the substrate while the mask stage and the substrate stage undergo a synchronous scan. For the scanning exposure apparatus, there is known a multilens scanning exposure apparatus that has a plurality of projection optical systems arranged in series in a direction perpendicular to a scanning direction and disposed such that edge portions (joints) of projection regions of the projection optical systems overlap each other. The multilens scanning exposure apparatus allows the substrate to obtain large exposure regions while maintaining a favorable imaging property without using a large projection lens.

When exposure is performed by the exposure apparatus, patterns to be subsequently formed need to be superimposed with accuracy onto corresponding patterns already formed on the substrate. For this reason, high-accuracy alignment of the substrate is performed. The alignment of the substrate is usually performed using alignment marks provided on the substrate. Specifically, the alignment of the exposure regions is performed based on the alignment marks disposed outside the exposure regions on the substrate. In addition, the apparatus calculates deformation amounts of the exposure regions based on the positions of the alignment marks. Based on the calculated deformation amounts, the apparatus performs expansion and contraction, rotation, or shift of the patterns to be projected onto the photo resist applied on the substrate. Having this configuration, even when the substrate is deformed by heat, the apparatus can perform exposure in accordance with the deformation of the substrate as long as the deformation amounts fall within a control range.

However, there arises a problem as follows in using the exposure apparatus described above. When using an upsized mother glass, temperature distribution within a plane of the mother glass becomes nonuniform, and amounts of deformation by heat within the plane of the mother glass could consequently become nonuniform. In this case, the apparatus cannot perform exposure in accordance with the nonuniform distribution of deformation amounts only based on the alignment of the outside shapes of the exposure regions and the calculation of the deformation amounts of the outside shapes of the exposure regions. As a result, the alignment of the exposure regions could decrease in accuracy.

Especially when the distribution of deformation amounts within the plane becomes nonuniform, there are cases where some of the optical systems can perform exposure with accuracy while the others cannot. In such cases, the patterns that should be formed in succession over the exposure regions could be formed not in succession on the borders between the exposure regions. As a result, in displaying an image on a screen of a display panel produced by using this apparatus, streaky display irregularity occurs in the image. The streaky display irregularity could reduce the display quality of the display panel, so that it is preferable to prevent or minimize the occurrence of the streaky display irregularity as much as possible. However, in a production process of a liquid crystal display panel, this problem tends to arise accompanied by the recent trend of upsizing of a mother glass.

### CITATION LIST

### Patent Literature

PTL 1: JP2007-304546

### SUMMARY OF INVENTION

### Technical Problem

An object of the invention is to overcome the problem described above and to provide an exposure apparatus and an exposure method by which alignment of regions of a substrate that are to be exposed by optical systems can be performed with accuracy even if the substrate is deformed nonuniformly within a plane.

### Solution to Problem

In order to overcome the problems described above, a preferred embodiment of the present invention provides a step-and-scan exposure apparatus for performing exposure on a substrate that is a subject to be exposed that includes a plurality of mark detection systems capable of detecting alignment marks provided on the substrate, and a plurality of projection optical systems capable of illuminating corresponding project ion regions set on the subject with light energy, wherein the mark detection systems are disposed between the adjacent projection optical systems and on right and left sides of the endmost projection optical systems.

It is preferable that one of the alignment marks that is provided between a given one of the projection regions and another one of the projection regions that is adjacent to the given projection region is used in alignment for exposure of the given one projection region and in alignment for exposure of the another projection region.

Another preferred embodiment of the present invention provides an exposure method including the step of performing alignment for exposure of a given one of projection regions and alignment for exposure of another one of the projection regions that is adjacent to the given projection region by using one of alignment marks that is provided between the given one projection region and the another projection region.

### ADVANTAGEOUS EFFECTS OF INVENTION

According to the preferred embodiments of the present invention, the apparatus has a configuration such that adjustment of position, dimension, shape, inclination, scale and other properties can be performed on each of the projection regions that are to be exposed by the projection optical systems. Having the configuration, the apparatus can perform exposure with high accuracy even if the substrate that is the subject to be exposed is deformed. Especially having the configuration that the adjustment of the position can be performed on each of the projection regions that are to be exposed by the projection optical systems, the apparatus can perform exposure in accordance with the deformation of each of the projection regions even if the substrate is deformed nonuniformly within a plane.

In addition, because the apparatus uses the one of the alignment marks that is provided between the adjacent projection regions, the required number of the mark detection systems is the number obtained by adding one to the number of the projection optical systems, which minimizes or prevents increase of the mark detection systems.

### BRIEF DESCRIPTION OF DRAWINGS

FIG. 1 is a perspective view showing a schematic configuration of an exposure apparatus according to one preferred embodiment of the present invention.

FIG. 2 is a plan view schematically showing the shapes of projection images that are formed from light energy (exposing energy) projected from a plurality of projection optical systems, mutual positional relations between the projection images that are formed from the light energy projected from the plurality of projection optical systems, and positional relations between positions at which mark detection systems pick up images and the projection images.

FIG. 3 is a plan view schematically showing the configuration of a substrate that is a subject to be exposed, a region to be exposed, projection regions to be illuminated with light energy projected from the projection optical systems, and the positions at which the mark detection systems pick up the images (i.e., the positions of the alignment marks to be detected by the mark detection systems).

### DESCRIPTION OF EMBODIMENTS

Detailed descriptions of preferred embodiments of the present invention will now be provided with reference to the accompanying drawings.

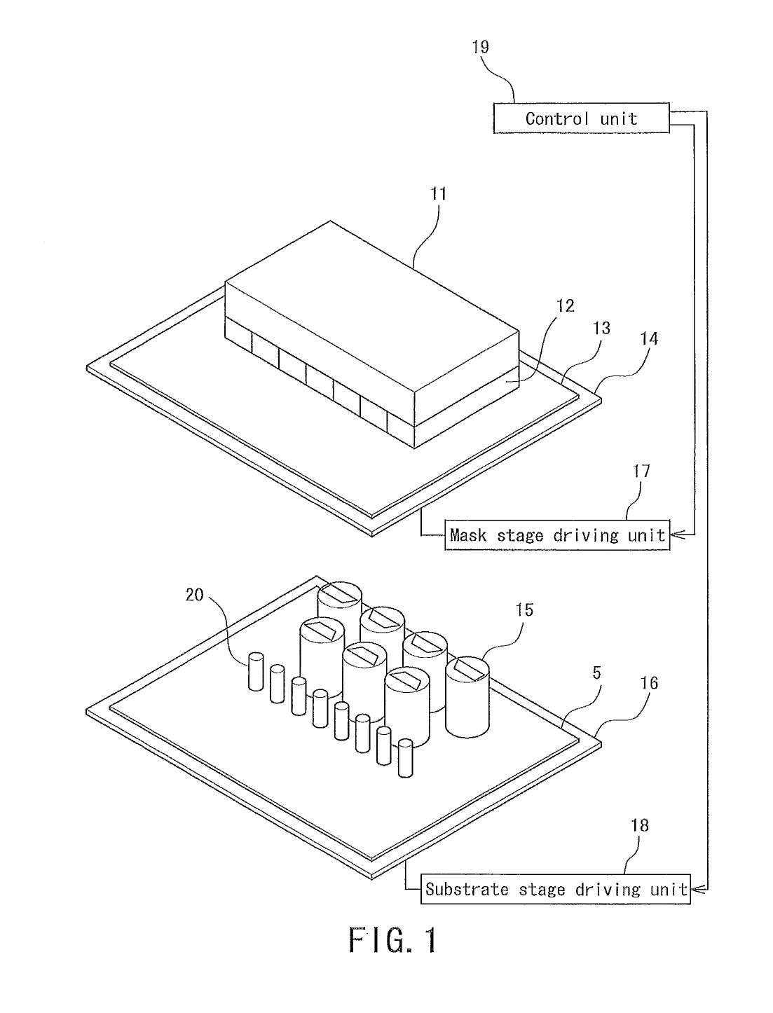

FIG. 1 is a perspective view showing a schematic configuration of an exposure apparatus 1 according to one preferred embodiment of the present invention. The exposure apparatus 1 according to the preferred embodiment of the present invention is a multilens scanning exposure apparatus, and accordingly includes a plurality of projection optical systems 15 capable of illuminating a substrate 5 that is a subject to be exposed with light energy (exposing light). The projection optical systems 15 are arranged to perform exposure on the substrate 5 (to be specific, on a photo resist applied thereon) while the substrate 5 (the substrate on which the photo resist is applied) undergoes a scan.

As shown in FIG. 1, the exposure apparatus 1 according to the preferred embodiment of the present invention includes an illumination unit 11, a predetermined number of plurality of illumination modules 12, a photo mask 13, a mask stage 14, a mask stage driving unit 17, the predetermined number of plurality of projection optical systems 15, a predetermined number of plurality of alignment mark detection systems 20, a substrate stage 16, a substrate stage driving unit 18, and a control unit 19.

The illumination unit 11 is arranged to illuminate the photo mask 13 placed on the mask stage 14 with the light energy (exposing light). A same illumination unit as used in a conventional general lens scanning exposure apparatus can be used for the illumination unit 11. A detailed description of the illumination unit 11 is accordingly omitted. A brief description of the illumination unit 11 will be provided. For example, the illumination unit 11 includes alight source, a converging mirror, a dichroic mirror, a wavelength-selective filter, alight guide, and other given members. The light source is capable of emitting light energy (exposing light) with given wavelengths. An extra high pressure mercury lamp can be preferably used for the light source. The converging mirror is capable of converging the light energy (exposing light) emitted from the light source. The dichroic mirror is arranged to reflect the light energy (exposing light) with wavelengths required for exposure, and transmit the light energy (exposing light) with the other wavelengths. The wavelength-selective filter is capable of further transmitting the light energy (exposing light) with wavelengths required for exposure that is selected from the light energy (exposing light) reflected by the dichroic mirror. The light guide is arranged to bifurcate the light energy (exposing light) that is transmitted by the wavelength-selective filter into a predetermined plural number of light energy (exposing light).

The illumination modules 12 are arranged to receive illumination of the light energy (exposing light) bifurcated by the light guide of the illumination unit 11, and illuminate a surface of the photo mask 13 with the light energy. Same illumination modules as used in a conventional general step-and-scan exposure apparatus can be used for the illumination modules 12. For example, the illumination modules 12 each include illumination shutters, relay lenses, fly-eye lenses that define optical integrators, condenser lenses, and other elements. The illumination shutters are disposed insertable into and removable from an optical path of the light energy (exposing light), and arranged to shield the light energy (exposing light) when inserted into the optical path while transmitting the light energy (exposing light) when removed from the optical path. Thus, the illumination shutters can shield or transmit the light energy (exposing light). The light emitted from the illumination modules 12 illuminates different regions of the photo mask 13.

The photo mask 13 is an optical member having the shape of a plate that is preferably made of fused quartz. The photo mask 13 includes a translucent portion that transmits the light energy (exposing light), and a light shielding portion that shields the light energy (exposing light). The translucent portion has a given pattern, and the light shielding portion has a given pattern. The patterns of the translucent portion and the light shielding portion are projected (transferred) onto the substrate 5 that is the subject to be exposed (onto the photo resist applied thereon).

The mask stage 14 is a stage on which the photo mask 13 is placed. In order that scan and exposure can be performed in a given direction, the mask stage 14 is movable in the given scanning direction A. In addition, the mask stage 14 is movable also in a direction substantially perpendicular to the scanning direction A. Further, the mask stage 14 is finely movable in an up/down direction and in a rotation direction having the up/down direction as its rotation axis. The mask stage driving unit 17 includes a motor and other members arranged to move or finely move the mask stage 14 in those directions. The mask stage driving unit 17 is controlled by the control unit 19. A same mask stage and a same mask stage driving unit as used in a conventional general step-and-scan exposure apparatus can be used for the mask stage 14 and the mask stage driving unit 17. Detailed descriptions thereof are accordingly omitted.

The projection optical systems 15 are arranged to produce images of the patterns of the translucent portion and the light shielding portion of the photo mask 13 on the substrate 5 that is the subject to be exposed. Thus, the patterns of the translucent portion and the light shielding portion of the photo mask 13 can be projected (transferred) onto the photo resist applied on the substrate 5. Same projection optical systems as used in a conventional general lens scanning exposure apparatus can be used for the projection optical systems 15. A detailed description thereof is accordingly omitted. A brief description of the projection optical systems 15 will be provided. For example, the projection optical systems 15 each include lens shifters arranged to adjust imaging properties (e.g., imaging positions, expansion and contraction, rotation, deformation) of the light energy (exposing light), field diaphragms arranged to set projection images E (a “projection image” refers to a mapping exposed by one projection optical system 15), objective lenses through which the light energy (exposing light) passes to form images on the substrate 5, and other given optical elements. The lens shifters, the field diaphragms, the objective lenses, and the other given optical elements are each disposed in lens tubes.

The lens shifters are optical elements disposed on the optical paths of the light energy (exposing light). Adjustment of the postures of the lens shifters allows adjustment of the optical paths of the light energy (exposing light). The adjustment of the optical paths of the light energy (exposing light) allows adjustment of shift (position, displacement), scaling (expansion, contraction), rotation, and deformation of the projection images E that are formed on the substrate 5.

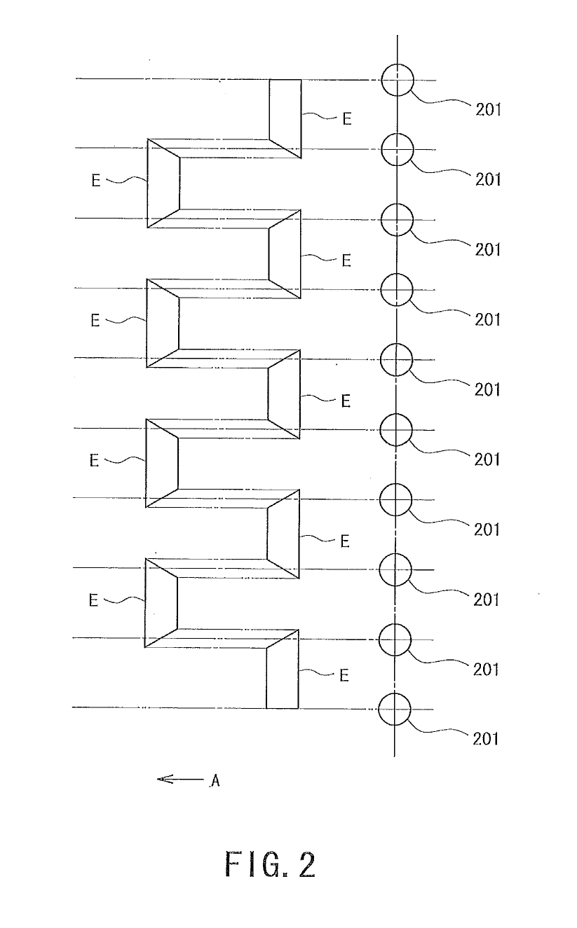

The projection optical systems 15 are disposed along the direction substantially perpendicular to the scanning direction A of the photo mask 13 and the substrate so as to have a substantial zigzag configuration. FIG. 2 is a plan view schematically showing the shapes of projection images E that are formed from the light energy (exposing light) projected from the projection optical systems 15, mutual positional relations between the projection images E that are formed from the light energy (exposing light) projected from the projection optical systems 15, and positional relations between positions at which the mark detection systems 20 pick up images and the projection images E. As shown in FIG. 2, each of the projection images E formed from the light energy (exposing light) projected from the projection optical systems 15 has the shape of a substantial trapezoid. In addition, the projection images E formed from the light energy (exposing light) projected from the projection optical systems 15 are disposed along the direction substantially perpendicular to the scanning direction A so as to have a substantial zigzag configuration.

Further, the projection images E formed from the light energy (exposing light) have a configuration such that edge portions (regions including the oblique sides of the trapezoids, i.e., joints) of the adjacent projection images E overlap each other along the direction substantially perpendicular to the scanning direction A. With this configuration, exposure amounts of the joints, and exposure amounts of the regions of the projection images E other than the joints can be made almost equal when the scan and exposure is performed in the scanning direction A. With this configuration, smooth changes in optical aberration or exposure amount among the adjacent projection images E can be achieved.

The following description is provided referring to FIG. 1 again. The substrate stage 16 is a stage on which the substrate 5 (the substrate on which the photo resist is applied) that is the subject to be exposed is placed. For example, the substrate 5 can be placed on the substrate stage 16 by being supported by a substrate holder (not shown). In order that scan and exposure can be performed in the given scanning direction A, the substrate stage 16 is movable in the given scanning direction A similarly to the mask stage 14. In addition, the substrate stage 16 is movable also in the direction perpendicular to the scanning direction A.

The substrate stage driving unit 18 is capable of moving the substrate 5. The substrate stage driving unit 18 includes a motor and other members arranged to drive the substrate stage 16. The substrate stage driving unit 18 is controlled by the control unit 19.

The mask stage driving unit 17 and the substrate stage driving unit 18 are individually driven by the control unit 19. Thus, the mask stage 14 and the substrate stage 16 can be moved individually by driving of the mask stage driving unit 17 and driving of the substrate stage driving unit 18, respectively. The control unit 19 controls the mask stage driving unit 17 and the substrate stage driving unit 18 while monitoring the position of the mask stage 14 and the position of the substrate stage 16. Thus, the photo mask 13 and the substrate 5 that is the subject to be exposed can be synchronously moved in a given direction at a given speed with respect to the illumination unit 11 and the projection optical systems 15.

As described above, the exposure apparatus 1 according to the preferred embodiment of the present invention is capable of synchronously moving the photo mask 13 (the mask stage 14 on which the photo mask 13 is placed) and the substrate 5 that is the subject to be exposed (the substrate stage 16 on which the substrate 5 is placed) in the scanning direction A with respect to the illumination unit 11 and the projection optical systems 15. The exposure apparatus 1 according to the preferred embodiment of the present invention is capable of illuminating the photo mask 13 with the light energy (exposing light), and projecting (transferring) the patterns of the translucent portion and the light shielding portion of the photo mask 13 onto the substrate (onto the photo resist applied thereon) via the projection optical systems 15.

The exposure apparatus 1 according to the preferred embodiment of the present invention includes the mark detection systems 20, the number of which is set to be the number of the projection optical systems 15 plus one. The mark detection systems 20 are arranged substantially in series in the arranging direction of the projection optical systems 15, and disposed between the adjacent projection optical systems 15 and on right and left sides of the endmost projection optical systems 15. To be specific, as shown in FIG. 2, the mark detection systems 20 are arranged to pick up images of given regions located at the joints (i.e., given regions located on extensions of the joints along the scanning direction A) of the projection images E of the projection optical systems 15, and images of given regions located on the right and left sides of the endmost projection images E in the direction substantially perpendicular to the scanning direction A.

Accordingly, the regions of which the images are picked up by the mark detection systems 20 are arranged in series in the direction substantially perpendicular to the scanning direction A. Shown in FIG. 2 is the configuration that the regions of which the images are picked up are located outside of the projection images E having the zigzag configuration; however, the present invention is not limited hereto. It is also preferable that the regions of which the images are picked up are located so as to be sandwiched by the projection images E. In addition, shown in FIG. 2 is the configuration that the regions of which the images are picked up are arranged in series (in a line); however, the present invention is not limited hereto. It is essential only that the mark detection systems 20 should pick up images of given regions located at the joints (i.e., given regions located on extensions of the joints along the scanning direction A).

The mark detection systems 20 are disposed opposed to alignment marks 52 provided on the substrate 5. Thus, the mark detection systems 20 are capable of detecting the alignment marks 52 provided on the substrate 5.

Same mark detection systems as used in a conventional general lens scanning exposure apparatus can be used for the mark detection systems 20 of the exposure apparatus 1 according to the preferred embodiment of the present invention. A detailed description of the mark detection systems 20 is accordingly omitted. A brief description of the mark detection systems 20 will be provided. For example, the mark detection systems 20 each include light sources for alignment, and image-pickup units. Halogen lamps capable of emitting detection light with a given wavelength can be used for the light sources for alignment. A variety of known CCD cameras can be used for the image-pickup units. The image-pickup units are arranged to transmit data on the picked up images to the control unit 19. The control unit 19 is arranged to perform image processing on the image data, and calculate positional information of the alignment marks 52 of which the images are picked up.

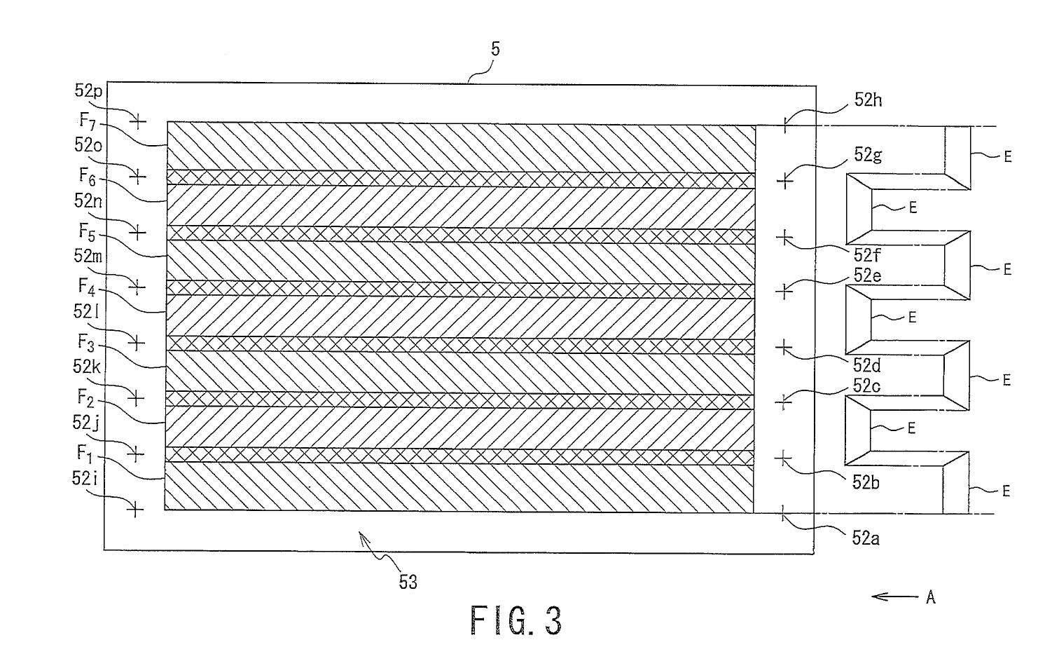

FIG. 3 is a plan view schematically showing the configuration of the substrate 5 that is the subject to be exposed, a region 53 to be exposed, projection regions F to be illuminated with the light energy projected from the projection optical systems 15 (a “projection region” refers to a region to be illuminated with the light energy projected from one projection optical system 15), and the positions at which the mark detection systems 20 pick up the images (i.e., the positions of the alignment marks 52 to be detected by the mark detection systems 20). The region 53 consists of the plurality of projection regions F. In FIG. 3, the region 53 consists of the seven projection regions F (F₁ to F₇). The projection regions F have a configuration such that portions of the adjacent projection regions F overlap each other. The overlapping portions are the joints.

As shown in FIG. 3, each of the projection regions F₁ to F₇ has the shape of a long and narrow belt along the scanning direction A. The plurality of projection regions F₁ to F₇ (seven in the preferred embodiment of the present invention) are disposed in the direction perpendicular to the scanning direction A. The projection regions F₁ to F₇ have a configuration such that portions of the adjacent projection regions F₁ to F₇ overlap each other (the overlapping portions are the joints).

The plurality of alignment marks 52 that are used for alignment for exposure are provided on the substrate 5 that is the subject to be exposed (the substrate on which the photo resist is applied). To be specific, the alignment marks 52 are disposed outside the region 53 to be exposed and near the four corners of each of the projection regions F₁ to F₇, as shown in FIG. 3. In other words, the alignment marks 52 are disposed outside the region 53 to be exposed, and on substantial extensions of the joints of the adjacent projection regions F₁ to F₇ and on extensions of the right and left sides of the endmost projection regions F₁ and F₇ (i.e., the right and left sides that are parallel to the scanning direction A). Thus, the alignment marks 52 are disposed outside the both ends of the scanning direction A of the region 53 to be exposed (the alignment marks 52a to 52h outside one end, the alignment marks 52i to 52p outside the other end), the number of the alignment marks 52 outside one end being set to be the number of the projection regions F₁ to F₇ plus one. Thus, the alignment marks 52 (52a to 52h, 52i to 52p) are arranged in series in the direction substantially perpendicular to the scanning direction A. It is preferable that each of the alignment marks 52 has the shape of the letter X. It is also preferable that the alignment marks 52 have the shape of a circle, or a square.

Accordingly, alignment of the projection region F₁ and calculation of the shape of the projection region F₁ can be performed based on the alignment marks 52a, 52b, 52i and 52j that are provided outside the four corners of the projection region F₁. In a similar manner, alignment of the projection region F₂ and calculation of the shape of the projection region F₂ can be performed based on the alignment marks 52b, 52c, 52j and 52k that are provided outside the four corners of the projection region F₂.

The alignment marks provided between the adjacent projection regions F can be shared by the adjacent projection regions F as described above. For example, the projection region F₁ and the projection region F₂ can share the alignment marks 52b and 52j. The projection region F₂ and the projection region F₃ can share the alignment marks 52c and 52k. Accordingly, the alignment marks can be shared in the alignment for exposure and in the calculation of the shapes of the projection regions F, which minimizes or prevents increase of the mark detection systems 20. In addition, even if deformation amounts of the region 53 to be exposed become nonuniform because of nonuniform temperature distribution in the substrate 5, for example, the alignment for exposure and the calculation of the shape can be performed on each of the projection regions F. Therefore, the alignment for exposure can be improved in accuracy while increase of the image-pickup units is minimized or prevented.

Next, a description of one example of operations of the alignment processing and the exposure processing will be provided.

The control unit 19 controls the substrate stage 16 to move such that the mark detection systems 20 are opposed to the corresponding alignment marks 52 (52a to 52h) disposed outside the one end of the scanning direction A of the region 53 to be exposed. In the preferred embodiment of the present invention, the alignment marks 52 are disposed on the substrate 5 at intervals predetermined based on the intervals at which the mark detection systems 20 are disposed. Accordingly, by moving the substrate 5 to a given position, the mark detection systems 20 are opposed to the corresponding alignment marks 52 (52a to 52h) at the same time. Then, the mark detection systems 20 detect the corresponding alignment marks 52 (52a to 52h).

Then, the control unit 19 controls the substrate stage 16 to move in the scanning direction A such that the mark detection systems 20 are opposed to the corresponding alignment marks 52 (52i to 52p) disposed outside the other end of the scanning direction A of the region 53 to be exposed. The mark detection systems 20 detect the corresponding alignment marks 52 (52i to 52p) at the same time.

In this manner, the control unit 19 detects the four alignment marks 52 provided outside the four corners of each of the projection regions F (F₁ to F₇). Then, the control unit 19 calculates the positional information of the alignment marks 52, and based on the positional information, calculates the dimensions and the shapes of the projection regions F (F₁ to F₇). Further, based on the calculation result, the control unit 19 calculates correction data including shift amounts, scaling amounts and rotation amounts of the patterns to be projected by the projection optical systems 15.

Then, the control unit 19 corrects imaging properties of each of the projection optical systems 15 based on the calculated correction parameters, and performs exposure on each of the projection regions F (F₁ to F₇). To be specific, the projection optical systems 15 perform exposure on the corresponding projection regions F (F₁ to F₇) while the mask stage 14 and the substrate stage 16 are moved synchronously in the scanning direction A.

In other words, the control unit 19 controls the substrate stage 16 to move such that the projection optical systems 15 are opposed to the one end of the scanning direction A of the region 53 to be exposed. At the same time, the control unit 19 controls also the mask stage 14 to move to the one end of the scanning direction A of the region 53 to be exposed, and performs alignment of the photo mask 13 with respect to the substrate 5. Then, while moving the photo mask 13 and the substrate 5 synchronously in the scanning direction A with respect to the projection optical systems 15, the control unit 19 performs exposure processing on the projection regions F by controlling the illumination unit 11 (the illumination modules 12) to illuminate the photo mask 13. The control unit 19 performs the scan and exposure while adjusting the postures of the lens shifters based on the correction parameters that are obtained in advance.

According to the operations described above, even if deformation amounts of the region 53 to be exposed become nonuniform because of nonuniform temperature distribution in the substrate 5, for example, the alignment for exposure and the calculation of the shape can be performed on each of the projection regions F. Therefore, the alignment for exposure can be improved in accuracy.

### INDUSTRIAL APPLICABILITY

The present invention can be applied also to a scanning exposure apparatus including one projection optical system, while described in the preferred embodiments of the present invention is the multilens scanning exposure apparatus that has the plurality of adjacent projection optical systems. The present invention is not limited to the application to a scanning exposure apparatus, and can be applied further to a full-plate exposure apparatus (so-called stepper).

1. A step-and-scan exposure apparatus for performing exposure on a substrate that is a subject to be exposed, the apparatus comprising:
a plurality of mark detection systems capable of detecting alignment marks provided on the substrate; and
a plurality of projection optical systems capable of illuminating corresponding projection regions set on the subject with light energy,
wherein the mark detection systems are disposed between the adjacent projection optical systems and on right and left sides of the endmost projection optical systems.

2. The apparatus according to claim 1, wherein the apparatus performs alignment for exposure of a given one of the projection regions and alignment for exposure of another one of the projection regions that is adjacent to the given one projection region by using one of the alignment marks that is provided between the given one projection region and the another projection region.

3. An exposure method comprising the step of performing alignment for exposure of a given one of projection regions and alignment for exposure of another one of the projection regions that is adjacent to the given one projection region by using one of alignment marks that is provided between the given one projection region and the another projection region.
